(19) United States
(12) Patent Application Publication
(10) Pub. No.: US 2010/0231651 A1
(43) Pub. Date: Sep. 16, 2010

(54) Large-scale ink-jet printer having pre-printing, printing, and post-printing processing modules

(76) Inventors: Hsien Chang Lin, Hsi Chih City (TW); Chin-Lung Yang, Hsi Chih City (TW)

Correspondence Address: Muncy, Geissler, Olds & Lowe, PLLC, 4000 Legato Road, Suite 310, FAIRFAX, VA, 22033, US

(21) Appl. No.: 11/898,484

(22) Filed: Sep. 12, 2007

(51) Int. Cl. B41J 2/14

(52) U.S. Cl. 347/49

(57) ABSTRACT

A large-scale ink-jet printer having pre-printing, printing, and post-printing processing modules comprises a main body, a pre-printing processing module, a post-printing processing module, and a transporting device. The main body has a front end and a rear end and is provided with a printing processing module for proceeding with printing procedures on the center of the main body. The pre-printing processing module is provided on the front end of the main body while the post-printing processing module is provided on the rear end of the main body. The transporting device is connected with the printing, pre-printing, and the post-printing processing modules for transporting a material to be processed by the pre-printing, printing, and post-printing processing modules sequentially.

### BACKGROUND OF THE INVENTION

1. Field of the Invention

The present invention relates to a large-scale ink-jet printer and more particularly to a large-scale ink-jet printer that is of simple structure and incorporated with a pre-printing module and a post-printing module wherein different pre-printing and post-printing modules can be chosen according to the needs of users, so that manufacturing cost can be reduced and printing efficiency and quality can be improved.

2. Description of the Prior Art

Printer has become one of necessary and basic peripheral equipments in computer or printing industry. With the advancement in color ink-jet technology, an expected color can be printed by spraying colors of different concentrations at the same position via cartridges of different ink colors. Therefore, in addition to usual documents, assignments, and reports, it is also possible for an ink-jet printer to be used for printing photographs.

Manufacturing ink-jet products is a global tendency in printing industry. An ink jet printer can be used for printing rapidly products that are in small amounts and of diverse kinds. It is more advantageous in this competent times for users to use ink jet printers because it needs not to manufacture separate screens when an ink-jet printer is used, which saves time and efforts of producing separate screens.

When UV digital printing is applied, ink will peel off or be scraped easily from the surface of a product if the product is with poor surface adhesive ability. In order to solve this problem, the common solution adopted recently is to proceed with a pre-printing process before printing by using extra equipments or workers, and the pre-printing process is to coat a layer of material on a material to be printed or process the surface of the material in order to endow the surface with adhesive ability for making it able to combine with the ink.

After printing procedure, a post-printing process is necessary to be adopted by means of using another group of equipments or workers for protecting the ink printed on the products from being scraped by external force or for endowing the surfaces of the products with bright effect, and the post-printing process is to coat bright ink or other specific materials on the surfaces of the printed materials so that the surfaces of the printed materials can show bright effects and have anti-scraping ability.

Because the pre-printing and post-printing processes mentioned above are adopted by means of using extra equipments and workers, it is not economic in aspects of manufacturing cost and efficiency when applied in mass production and wide-range printing.

### SUMMARY OF THE INVENTION

The main object of the present invention is to provide a large-scale ink-jet printer of simple structure having pre-printing, printing, and post-printing processing modules, by which manufacturing cost can be reduced and printing efficiency and quality can be improved.

In order to achieve the above object, the present invention provides a large-scale ink-jet printer having pre-printing, printing, and post-printing processing modules, which comprises a main body, a pre-printing processing module, a post-printing processing module, and a transporting device. The main body has a front end and a rear end and is provided with a printing processing module for proceeding with printing procedures on the center of the main body. The pre-printing processing module is provided on the front end of the main body while the post-printing processing module is provided on the rear end of the main body. The transporting device is connected with the printing processing module, pre-printing, and the post-printing processing modules for transporting a material to be processed by the pre-printing, printing, and post-printing processing modules sequentially.

The following detailed description, given by way of examples and not intended to limit the invention solely to the embodiments described herein, will best be understood in conjunction with the accompanying drawings.

### BRIEF DESCRIPTION OF THE DRAWINGS

FIG. 1 shows a structural schematic view of an embodiment of the present invention.

### DETAILED DESCRIPTION OF THE PREFERRED EMBODIMENTS

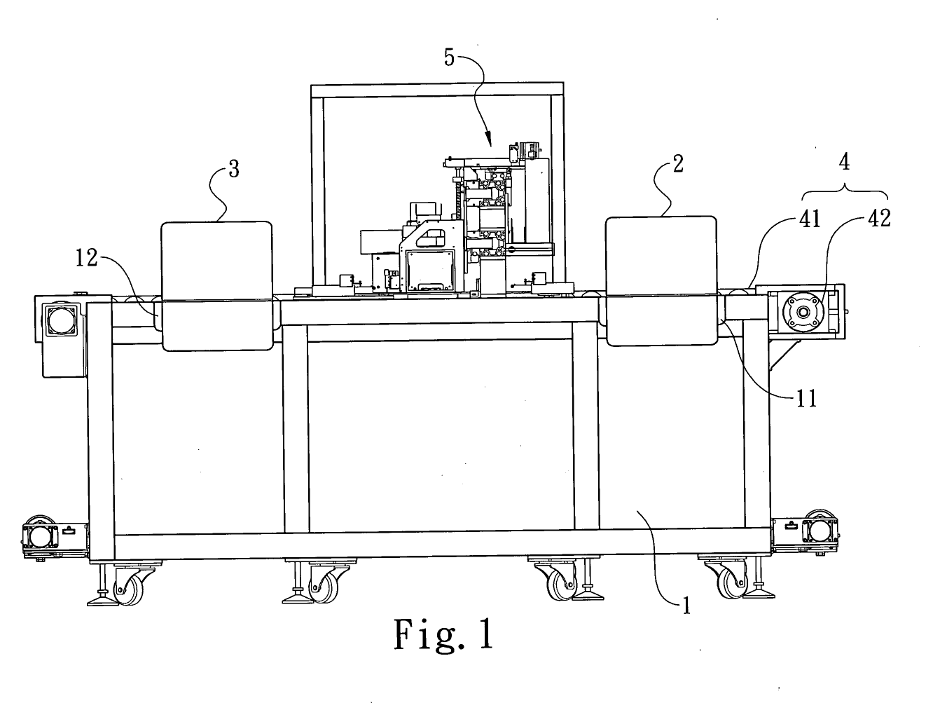

As shown in FIG. 1, it shows an embodiment of a large-scale ink-jet printer having pre-printing, printing, and post-printing processing modules according to the present invention. The large-scale ink-jet printer comprises a main body 1, a pre-printing processing module 2, a post-printing processing module 3, and a transporting device 4.

The main body 1 has a front end and a rear end and is provided with a printing processing module 5 for proceeding with printing procedures on the center of the main body. Two modular seats 11, 12 are provided on the front and the rear ends of the main body 1 respectively. The pre-printing processing module 2 is disposed in one modular seat 11 provided on the front end of the main body 1 while the post-printing processing module 3 is disposed in the other modular seat 12 provided on the rear end of the main body 1. The pre-printing module 2 can be a corona discharge module, a primer process module, a flame treating module, or a plasma treating module while the post-printing module 3 can be a brightening treating module or a lamination module. The transporting device 4 includes a transporting belt 41 and a motor 42 for controlling the transporting belt 41. The transporting device 4 is connected with the printing processing module 5, pre-printing processing module 2, and the post-printing processing module 3 for transporting a material to be processed by the pre-printing 2, printing 5, and post-printing 3 processing modules sequentially.

When in practice, the pre-printing processing module 2 (for example, a corona discharge module) is placed in the modular seat 11 on the front end of the main body 1 and the post-printing processing module 3 is placed in the modular seat 12 on the rear end of the main body 1. When a material to be printed is placed on the transporting belt 41 of the transporting device 4 at the front end of the main body 1 and starts to be transported, the material will first pass through the pre-printing processing module 2 to proceed with corona discharge. Then the material will be transported to the printing processing module 5 in the center of the main body 1 to proceed with printing procedure. Finally, the material will be transported to the post-printing processing module 3 to proceed with brightening treatment.

Therefore, a user can operate pre-printing, printing, and post-printing processes within the same digital printing procedure by using the large-scale ink-jet printer according to the present invention. Compared with the present invention, the pre-printing process and the post-printing process in the prior art need extra and special equipments and workers. Thus, when the present invention is applied in mass production and wide-range printing, the manufacturing cost can be reduced and the printing efficiency and outputting quality can be improved.

Moreover, both the front and the rear ends of the main body 1 are provided with a modular seat 11, 12 respectively for detachable connection with the pre-printing processing module 2 and post-printing processing module 3. A user can select one kind of the pre-printing processes including corona discharge, primer process, flame treatment, and plasma treatment, and one kind of post-printing processes including brightening treatment and lamination by changing the modules.

Accordingly, as disclosed in the above description and attached drawings, the present invention can provide a large-scale ink-jet printer of simple structure having pre-printing, printing, and post-printing processing modules, by using which manufacturing cost can be reduced and printing efficiency and quality can be improved. It is new and can be put into industrial use.

It should be understood that different modifications and variations could be made from the disclosures of the present invention by the people familiar in the art, which should be deemed without departing the spirit of the present invention.

What is claimed is:

1. A large-scale ink-jet printer having pre-printing, printing, and post-printing processing modules, comprising:
a main body having a front end and a rear end and provided with a printing processing module for proceeding with printing procedures on the center of the main body;
a pre-printing processing module provided on the front end of the main body;
a post-printing processing module provided on the rear end of the main body;
a transporting device connected with the printing, pre-printing, and the post-printing processing module for transporting a material to be processed by the pre-printing, printing, and post-printing processing modules sequentially.

2. The large-scale ink-jet printer having pre-printing, printing, and post-printing processing modules as claimed in claim 1, wherein the front and the rear ends of the main body are provided with a modular seat respectively used for detachable connection with the pre-printing and post-printing processing modules.

3. The large-scale ink-jet printer having pre-printing, printing, and post-printing processing modules as claimed in claim 2, wherein the pre-printing module is a corona discharge module, a primer process module, a flame treating module, or a plasma treating module.

4. The large-scale ink-jet printer having pre-printing, printing, and post-printing processing modules as claimed in claim 2, wherein the post-printing module is a brightening treating module or a lamination module.

5. The large-scale ink-jet printer having pre-printing, printing, and post-printing processing modules as claimed in claim 1, wherein the pre-printing module is a corona treating module, a primer process module, a flame treating module, or a plasma treating module.

6. The large-scale ink-jet printer having pre-printing, printing, and post-printing processing modules as claimed in claim 1, wherein the post-printing module is a brightening treating module or a lamination module.

7. The large-scale ink jet printer having pre-printing, printing, and post-printing processing modules as claimed in claim 1, wherein the transporting device includes a transporting belt and a motor for controlling the transporting belt.
